(19) United States
(12) Patent Application Publication
(10) Pub. No.: US 2026/0274039 A1
(43) Pub. Date: Sep. 17, 2026

(54) SYSTEM AND METHOD OF CONTROLLING AUTOMATIC VENTILATION FOR VEHICLE

(71) Applicants: Hyundai Motor Company, Seoul (KR); Kia Corporation, Seoul (KR)

(72) Inventors: Chong Li Pei, Yantai (CN); Ming Zhe Li, Yantai (CN); Xu Qiang Sun, Yantai (CN)

(21) Appl. No.: 19/380,692

(22) Filed: Nov. 5, 2025

(30) Foreign Application Priority Data
Nov. 5, 2024 (CN) 202411565767.9

(51) Int. Cl. B60H 1/00

(52) U.S. Cl. CPC B60H 1/00821; B60H 1/00764; B60H 1/00785

(57) ABSTRACT

The present disclosure relates to an automatic ventilation control system and control method for a vehicle. The system may include a mode button, a rain sensor and/or a wiper detection module, a vehicle speed sensor, an air conditioning control system, and an automatic ventilation controller. The automatic ventilation controller may be configured to determine whether the automatic ventilation mode is on, determine whether the rain sensor or the wiper detection module detects rain, determine whether the vehicle speed is within a predetermined range, determine whether the vehicle interior temperature approaches the set temperature based on the vehicle interior temperature and the set temperature, and control the vehicle to perform ventilation when the automatic ventilation mode is on, the rain sensor or the wiper detection module detects no rain, the vehicle speed is within the predetermined range, and the vehicle interior temperature approaches the set temperature.

### CROSS-REFERENCE TO RELATED APPLICATION

This application claims priority to and the benefit of Chinese Patent Application No. 202411565767.9 filed with the Chinese National Intellectual Property Administration on Nov. 5, 2024, the entire contents of which are incorporated herein by reference.

### TECHNICAL FIELD

The present disclosure relates to a vehicle, and more particularly, to an automatic ventilation control system and control method for a vehicle.

### BACKGROUND

As vehicle technology continues to advance, consumers are demanding improved performance in various aspects of their vehicles. Maintaining good air quality inside a vehicle is also one of consumers' demands for comfort. The air quality inside a vehicle may be an intuitive experience for an occupant and may affect their mood.

A conventional vehicle ventilation method has mainly been implemented through manual operation of an air conditioner, a sunroof, and an airflow. However, the manual operation by a driver may cause operational inconvenience and increase a driving risk. Accordingly, an automatic ventilation control system and control method for a vehicle are needed.

The above information disclosed in this Background section is only for enhancement of understanding of the background of the present disclosure, and therefore, it may contain information that does not form the prior art that is already publicly known, available, or in use.

### SUMMARY

Embodiments of the present disclosure provide an automatic ventilation control system and control method for a vehicle capable of automatically introducing fresh air into an interior of the vehicle and discharging low-quality air inside the vehicle.

An embodiment of the present disclosure provides an automatic ventilation control system for a vehicle. The automatic ventilation control system may include a mode button, at least one of a rain sensor or a wiper detection module, a vehicle speed sensor, an air conditioning control system, and an automatic ventilation controller. The mode button may be configured to receive user handling to turn an automatic ventilation mode on or off. The vehicle speed sensor may be configured to detect a vehicle speed. The air conditioning control system may be configured to: receive a set temperature input by a user and detect a vehicle interior temperature. The automatic ventilation controller may be configured to determine whether the automatic ventilation mode is on based on handling received via the mode button, determine whether it is raining outside the vehicle through the rain sensor or the wiper detection module, determine whether the vehicle speed is within a predetermined range based on the vehicle speed detected by the vehicle speed sensor, determine whether the vehicle interior temperature approaches the set temperature based on the vehicle interior temperature detected by the air conditioning control system and the set temperature received by the air conditioning control system, and control the vehicle to perform ventilation when it is determined that the automatic ventilation mode is on, it is not raining outside the vehicle, the vehicle speed is within the predetermined range, and the vehicle interior temperature approaches the set temperature.

The automatic ventilation controller may be configured to determine whether the vehicle speed is greater than or equal to a first predetermined reference speed in a process of determining whether the vehicle speed is within the predetermined range; and to determine that the vehicle speed is within the predetermined range when the vehicle speed is less than the first predetermined reference speed.

The automatic ventilation controller may be configured to calculate an absolute value of a difference between the vehicle interior temperature and the set temperature in a process of determining whether the vehicle interior temperature approaches the set temperature; to determine whether the calculated absolute value of the difference between the vehicle interior temperature and the set temperature is less than or equal to a threshold value; and to determine that the vehicle interior temperature approaches the set temperature if the absolute value of the difference between the calculated vehicle interior temperature and the set temperature is less than or equal to the threshold value.

The predetermined range may be divided into at least two subranges, and the automatic ventilation controller may be configured to determine a subrange to which the vehicle speed belongs, after determining that the vehicle speed is within the predetermined range, and before determining whether the vehicle interior temperature approaches the set temperature; and to open a sunroof to a predetermined opening ratio, and the predetermined opening ratio of the sunroof when the vehicle speed is relatively high in different subranges is smaller than the predetermined opening ratio of the sunroof when the vehicle speed is relatively low, in a process of controlling a vehicle to perform ventilation.

The automatic ventilation controller may be configured to determine whether a predetermined time has elapsed after opening the sunroof to a predetermined opening ratio, and to close the sunroof if it is determined that the predetermined time has elapsed after opening the sunroof, and the predetermined time for opening the sunroof when the vehicle speed is relatively high may be shorter than the predetermined time for opening the sunroof when the vehicle speed is relatively low.

The automatic ventilation controller may be configured to determine whether it is raining outside the vehicle through the rain sensor or the wiper detection module; to determine whether the automatic ventilation mode is turned on based on the handling received via the mode button when it is determined that there is no rain outside the vehicle; to determine whether the vehicle speed is greater than or equal to a first predetermined reference speed when it is determined that the automatic ventilation mode is on; to determine whether the vehicle speed is greater than or equal to a second predetermined reference speed if the vehicle speed is determined to be less than the first predetermined reference speed, wherein the second reference speed is less than the first reference speed; to calculate an absolute value of a difference between the vehicle interior temperature detected by the air conditioning control system and the set temperature received by the air conditioning control system when the vehicle speed is determined to be greater than or equal to the second predetermined reference speed; to determine whether the calculated absolute value of the difference between the vehicle interior temperature and the set temperature is less than or equal to a threshold value; and to open a sunroof to a first predetermined opening ratio if the calculated absolute value of the difference between the vehicle interior temperature and the set temperature is less than or equal to the threshold value; to determine whether a first predetermined time has elapsed after opening the sunroof; to close the sunroof if it is determined that the first predetermined time has elapsed after the sunroof is opened; to determine whether the vehicle speed is greater than or equal to a third predetermined reference speed if the vehicle speed is determined to be less than the second predetermined reference speed, wherein the third reference speed is less than the second reference speed; to calculate an absolute value of a difference between the vehicle interior temperature detected by the air conditioning control system and the set temperature received by the air conditioning control system when the vehicle speed is determined to be greater than or equal to the third predetermined reference speed; to determine whether the calculated absolute value of the difference between the vehicle interior temperature and the set temperature is less than or equal to a threshold value; and to open a sunroof to a second predetermined opening ratio if the calculated absolute value of the difference between the vehicle interior temperature and the set temperature is less than or equal to the threshold value, the second predetermined opening ratio is greater than the first predetermined opening ratio; to determine whether a second predetermined time has elapsed after the sunroof is opened, wherein the second predetermined time is greater than the first predetermined time; to close the sunroof if it is determined that the second predetermined time has elapsed after the sunroof is opened; to determine whether the vehicle speed is greater than or equal to a fourth predetermined reference speed if the vehicle speed is determined to be less than the third predetermined reference speed, wherein the fourth reference speed is less than the third reference speed; to calculate an absolute value of a difference between the vehicle interior temperature detected by the air conditioning control system and the set temperature received by the air conditioning control system when the vehicle speed is determined to be greater than or equal to the fourth predetermined reference speed; to determine whether the calculated absolute value of the difference between the vehicle interior temperature and the set temperature is less than or equal to a threshold value; to open a sunroof to a third predetermined opening ratio if the calculated absolute value of the difference between the vehicle interior temperature and the set temperature is less than or equal to the threshold value, the third predetermined opening ratio is greater than the second predetermined opening ratio; to determine whether a third predetermined time has elapsed after the sunroof is opened, wherein the third predetermined time is greater than the second predetermined time; to close the sunroof if it is determined that the third predetermined time has elapsed after the sunroof is opened; to calculate an absolute value of a difference between the vehicle interior temperature detected by the air conditioning control system and the set temperature received by the air conditioning control system when the vehicle speed is determined to be less than the fourth predetermined reference speed; to determine whether the calculated absolute value of the difference between the vehicle interior temperature and the set temperature is less than or equal to a threshold value; to open a sunroof to a fourth predetermined opening ratio if the calculated absolute value of the difference between the vehicle interior temperature and the set temperature is less than or equal to the threshold value, the fourth predetermined opening ratio is greater than the third predetermined opening ratio; to determine whether a fourth predetermined time has elapsed after the sunroof is opened, wherein the fourth predetermined time is greater than the third predetermined time; and closing the sunroof if it is determined that the fourth predetermined time has elapsed after the sunroof is opened.

The automatic ventilation controller may be configured to turn on a defog function during the process of controlling the vehicle to perform ventilation.

The air conditioning control system may be configured to determine whether a defog function is currently turned on when a control command to activate the defog function is received from the automatic ventilation controller; to maintain the defog function to be activated at a current airflow speed if it is determined that the defog function is currently on; and to turn on the defog function and activate the defog function at an intermediate airflow speed if it is determined that the defog function is not currently turned on.

Another embodiment of the present disclosure provides an automatic ventilation control method for a vehicle. The method may include receiving user handling of turning an automatic ventilation mode on or off by a mode button; detecting a vehicle speed by a vehicle speed sensor; receiving a set temperature input by a user and detecting a vehicle interior temperature by an air conditioning control system; determining whether the automatic ventilation mode is turned on based on the handling received by the mode button, determining whether it is raining outside the vehicle through a rain sensor or a wiper detection module, determining whether the vehicle speed is within a predetermined range based on the vehicle speed detected by the vehicle speed sensor, and determining whether the vehicle interior temperature approaches the set temperature based on the vehicle interior temperature detected by the air conditioning control system and the set temperature received by the air conditioning control system, by an automatic ventilation controller; and controlling the vehicle to perform ventilation by the automatic ventilation controller when it is determined that the automatic ventilation mode is on, it is not raining outside the vehicle, the vehicle speed is within the predetermined range, and the vehicle interior temperature approaches the set temperature.

The determining of that the automatic ventilation mode is on, it is not raining outside the vehicle, the vehicle speed is within the predetermined range, and the vehicle interior temperature approaches the set temperature may include: determining whether it is raining outside the vehicle through the rain sensor or the wiper detection module; determining whether the automatic ventilation mode is turned on based on the handling received via the mode button when it is determined that there is no rain outside the vehicle; determining whether the vehicle speed is within the predetermined range based on the vehicle speed detected by the vehicle speed sensor when it is determined that the automatic ventilation mode is on; determining whether the vehicle interior temperature approaches the set temperature based on the vehicle interior temperature detected by the air conditioning control system and the set temperature received by the air conditioning control system when the vehicle speed is determined to be within the predetermined range; and controlling the vehicle to perform ventilation when the vehicle interior temperature is determined to approach the set temperature.

The determining of whether the vehicle speed is within the predetermined range may include: determining whether the vehicle speed detected by the vehicle speed sensor is greater than or equal to a predetermined first reference speed; and to determine that the vehicle speed is within the predetermined range when the vehicle speed is less than the first predetermined reference speed.

The method may further include, before determining whether the vehicle interior temperature approaches the set temperature after the vehicle speed is determined to be within the predetermined range, dividing the predetermined range by the automatic ventilation controller into at least two subranges, and determining a subrange to which the vehicle speed belongs, the controlling of the vehicle to perform ventilation may include opening the sunroof to the predetermined opening ratio, and in different subranges, the predetermined opening ratio of the sunroof when the vehicle speed is relatively high may smaller than the predetermined opening ratio of the sunroof when the vehicle speed is relatively low.

The opening of the sunroof to the predetermined opening ratio may include determining whether the vehicle speed is greater than or equal to a second predetermined reference speed after the vehicle speed is determined to be less than the first predetermined reference speed, wherein the second reference speed is less than the first reference speed; determining whether the vehicle interior temperature approaches the set temperature when the vehicle speed is determined to be greater than or equal to the second predetermined reference speed; opening the sunroof to a first predetermined opening ratio when the vehicle interior temperature is determined to approach the set temperature; determining whether the vehicle speed is greater than or equal to a third predetermined reference speed if the vehicle speed is determined to be less than the second predetermined reference speed, wherein the third reference speed is less than the second reference speed; determining whether the vehicle interior temperature approaches the set temperature when the vehicle speed is determined to be greater than or equal to the third predetermined reference speed; opening the sunroof to a second predetermined opening ratio when the vehicle interior temperature is determined to approach the set temperature, wherein the second predetermined opening ratio is greater than the first predetermined opening ratio; determining whether the vehicle speed is greater than or equal to a fourth predetermined reference speed if the vehicle speed is determined to be less than the third predetermined reference speed, wherein the fourth reference speed is less than the third reference speed; determining whether the vehicle interior temperature approaches the set temperature when the vehicle speed is determined to be greater than or equal to the fourth predetermined reference speed; opening the sunroof to a third predetermined opening ratio when the vehicle interior temperature is determined to approach the set temperature, wherein the third predetermined opening ratio is greater than the second predetermined opening ratio; determining whether the vehicle interior temperature approaches the set temperature when the vehicle speed is determined to be less than the fourth predetermined reference speed; and opening the sunroof to a fourth predetermined opening ratio when the vehicle interior temperature is determined to approach the set temperature, wherein the fourth predetermined opening ratio is greater than the third predetermined opening ratio.

The determining of whether the vehicle interior temperature approaches the set temperature may include calculating an absolute value of a difference between the vehicle interior temperature detected by the air conditioning control system and the set temperature received by the air conditioning control system; determining whether the calculated absolute value of the difference between the vehicle interior temperature and the set temperature is less than or equal to a threshold value; and determining that the vehicle interior temperature approaches the set temperature if the absolute value of the difference between the calculated vehicle interior temperature and the set temperature is less than or equal to the threshold value.

The controlling of the vehicle to perform ventilation may include determining whether a predetermined time has elapsed after opening the sunroof to a predetermined opening ratio; and closing the sunroof if it is determined that the predetermined time has elapsed after the sunroof is opened, and, in different subranges, the predetermined time for opening the sunroof when the vehicle speed is relatively high may be shorter than the predetermined time for opening the sunroof when the vehicle speed is relatively low.

The closing of the sunroof may include determining whether a first predetermined time has elapsed after opening the sunroof to a first predetermined opening ratio; closing the sunroof if it is determined that the first predetermined time has elapsed after the sunroof is opened; determining whether a second predetermined time has elapsed after opening the sunroof to a second predetermined opening ratio, wherein the second predetermined time is greater than the first predetermined time; closing the sunroof if it is determined that the second predetermined time has elapsed after the sunroof is opened; determining whether a third predetermined time has elapsed after opening the sunroof to a third predetermined opening ratio, wherein the third predetermined time is greater than the second predetermined time; closing the sunroof if it is determined that the third predetermined time has elapsed after the sunroof is opened; determining whether a fourth predetermined time has elapsed after opening the sunroof to a fourth predetermined opening ratio, wherein the fourth predetermined time is greater than the third predetermined time; and closing the sunroof if it is determined that the fourth predetermined time has elapsed after the sunroof is opened.

The controlling of the vehicle to perform ventilation may include turning on a defrosting function.

The automatic ventilation control system for a vehicle may further include determining whether the defog function is currently turned on by the air conditioning control system when a control command to activate the defog function from the automatic ventilation controller is received; maintaining the defog function to be activated at a current airflow speed by the air conditioning control system if it is determined that the defog function is currently turned on; and turning on the defog function and controlling it to be activated at an intermediate airflow speed by the air conditioning control system if it is determined that the defog function is not currently turned on.

The present disclosure uses the technical solution and has the following beneficial effects.

An embodiment of the present disclosure may implement a defrosting function for an air conditioning device and automatic linkage control of a sunroof to accelerate air exchange inside and outside a vehicle and may improve comfort inside the vehicle to prevent driving fatigue. An embodiment of the present disclosure may ensure that ventilation of the vehicle is performed on the premise that a vehicle interior temperature is controlled by considering a difference between the vehicle interior temperature and the set temperature. Accordingly, the comfort of the vehicle interior temperature was ensured and air exchange inside and outside the vehicle was implemented. An embodiment of the present disclosure may also dynamically control the sunroof opening ratio and the sunroof opening time according to a change in a vehicle speed and may implement low-noise air exchange inside and outside the vehicle. An embodiment of the present disclosure improves safety of a vehicle driving process by automatically controlling ventilation during the vehicle driving process, thereby avoiding manual handling by a driver.

Further, effects that can be obtained or expected from embodiments of the present disclosure are directly or suggestively described in the following detailed description. That is, various effects expected from embodiments of the present disclosure will be described in the following detailed description.

### BRIEF DESCRIPTION OF THE DRAWINGS

Hereinafter, embodiments of the present disclosure will be described in more detail by combining the drawings. For clarity, identical parts in different drawings are indicated with the same drawing symbols. It should be noted that the drawings are illustrative only and are not necessarily drawn to scale.

FIG. 1 illustrates a block diagram of an automatic ventilation control system for a vehicle according to an embodiment of the present disclosure.

FIG. 2A to FIG. 2D illustrate flowcharts of operation of an automatic ventilation controller according to an embodiment of the present disclosure.

FIG. 3 illustrates a flowchart showing a control method for automatic ventilation of a vehicle according to an embodiment of the present disclosure.

### DETAILED DESCRIPTION OF ILLUSTRATIVE EMBODIMENTS

Hereinafter, example embodiments of the present disclosure will be described in detail, these example embodiments are implemented based on the technical solution of the present disclosure and disclose detailed implementation methods and specific operation processes. It can be understood that the present specification is not intended to necessarily limit the present disclosure to these example embodiments of the present disclosure.

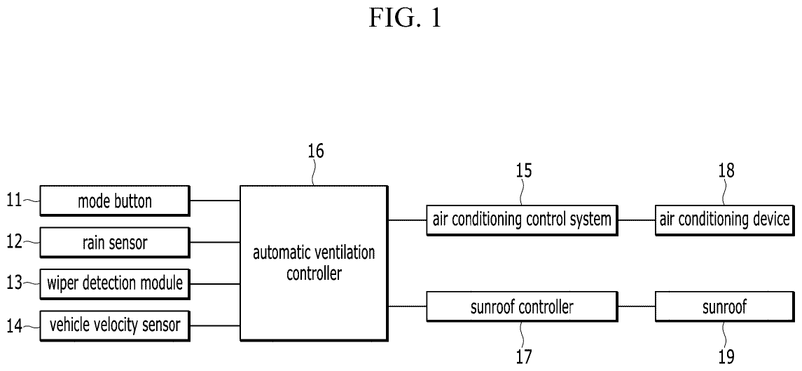

FIG. 1 illustrates a block diagram of an automatic ventilation control system for a vehicle according to an embodiment of the present disclosure. As illustrated in FIG. 1, an automatic ventilation control system for a vehicle according to an embodiment of the present disclosure may include a mode button 11, at least one of a rain sensor 12 and a wiper detection module 13, a vehicle speed sensor 14, an air conditioning control system 15, an automatic ventilation controller 16, a sunroof controller 17, an air conditioning (AC) device 18, and a sunroof 19.

As shown in FIG. 1, communication may be made between a mode button 11 and the automatic ventilation controller 16. The mode button 11 may be configured to receive user input to turn an automatic ventilation mode on or off. Specifically, the mode button 11 may be an on/off button, a selection button, a physical button (e.g., a button for executing various functions), a jog dial, and/or a touchpad. When a user presses the mode button 11, the mode button 11 may receive a user's press to generate a signal for turning the automatic ventilation mode on or off. The automatic ventilation controller 16 may be configured to determine whether the automatic ventilation mode is turned on based on the input received by the mode button 11. Specifically, the mode button 11 may send a signal for the automatic ventilation controller 16 to turn the automatic ventilation mode on or off, and the automatic ventilation controller 16 may determine whether the automatic ventilation mode is on based on the received signal.

Determining that the automatic ventilation mode is turned on by the automatic ventilation controller 16 is one of the prerequisites for the vehicle to proceed with ventilation.

In an embodiment, communication may be established between the rain sensor 12 and the automatic ventilation controller 16. The rain sensor 12 may be configured to detect an amount of rainfall outside the vehicle. Specifically, the rain sensor 12 may be mounted on a rearview mirror base inside the vehicle, emit an infrared ray toward a front windshield glass, and detect whether rain is falling on the front windshield glass by receiving the reflected infrared ray, thereby detecting the amount of rainfall outside the vehicle. In general, more rain on the front windshield glass results in less reflected far-infrared radiation. The automatic ventilation controller 16 may be configured to determine whether rain is falling outside the vehicle based on the amount of rain outside the vehicle detected by the rain sensor 12. Specifically, the rain sensor 12 may transmit the detected vehicle exterior rainfall information to the automatic ventilation controller 16, and the automatic ventilation controller 16 may determine whether it is raining outside the vehicle based on the received vehicle exterior rainfall information.

In another embodiment, communication may be made between the wiper detection module 13 and the automatic ventilation controller 16. The wiper detection module 13 may be configured to detect a wiper operation status. Specifically, the wiper detection module 13 may detect the wiper operation status by detecting an ON or OFF state of a wiper control switch. The automatic ventilation controller 16 may be configured to determine whether rain is falling outside the vehicle based on the wiper operation status detected by the wiper detection module 13. Specifically, the wiper detection module 13 may send a wiper operation or non-operation status to the automatic ventilation controller 16, when the automatic ventilation controller 16 receives the wiper operation status, may determine that it is raining outside the vehicle, and when the automatic ventilation controller 16 receives the wiper non-operation status, may determine that it is not raining outside the vehicle.

The automatic ventilation controller 16 is not limited to using either the rain sensor 12 or the wiper detection module 13 to determine whether it is raining outside the vehicle, and the automatic ventilation controller 16 may also use both the rain sensor 12 and the wiper detection module 13 to determine whether it is raining outside the vehicle.

Determining that there is no rain outside the vehicle by the automatic ventilation controller 16 is one of the prerequisites for the vehicle to proceed with ventilation.

Communication may be possible between the vehicle speed sensor 14 and the automatic ventilation controller 16. The vehicle speed sensor 14 may be configured to detect a vehicle speed V and may transmit the detected vehicle speed V to the automatic ventilation controller 16. The automatic ventilation controller 16 may be configured to determine whether the vehicle speed Vis within a predetermined range.

If the vehicle is ventilated at too high a speed, the noise generated while driving may affect a ride comfort of an occupant. Accordingly, the predetermined range may effectively indicate an upper limit set for the vehicle speed V. Specifically, in the process of determining whether the vehicle speed V is within a predetermined range, the automatic ventilation controller 16 may determine whether the received vehicle speed V is greater than or equal to a first predetermined reference speed V1 (e.g., 40 km/h), and if the vehicle speed V is less than the first predetermined reference speed V1, the automatic ventilation controller 16 may determine that the vehicle speed V is within the predetermined range.

Determining that the vehicle speed is within the predetermined range by the automatic ventilation controller 16 is one of the prerequisites for the vehicle to proceed with ventilation.

Communication may be possible between the air conditioning control system 15 and the automatic ventilation controller 16. The air conditioning control system 15 may be configured to receive a set temperature T1 input by a user. Specifically, the air conditioning control system 15 may include an input device such as a user interface, and a user may input the set temperature T1 through the user interface. The air conditioning control system 15 may control the air conditioning device 18 according to the set temperature T1 input by the user, thereby causing the air conditioning device 18 to discharge cold or warm air, adjusting the temperature inside the vehicle to the set temperature T1 input by the user. Additionally, the air conditioning control system 15 may detect a vehicle interior temperature T2. Specifically, the air conditioning control system 15 may include a vehicle interior temperature sensor for detecting the vehicle interior temperature T2. The air conditioning control system 15 may send the received set temperature T1 and the detected vehicle interior temperature T2 to the automatic ventilation controller 16. The automatic ventilation controller 16 may be configured to determine whether the vehicle interior temperature T2 approaches the set temperature T1 according to the vehicle interior temperature T2 detected by the air conditioning control system 15 and the set temperature T1 received by the air conditioning control system 15.

The vehicle interior temperature T2 approaching the set temperature T1 may indicate that the vehicle interior temperature T2 is approaching the set temperature T1 during a heating or cooling process, or that the vehicle interior temperature T2 has maintained equilibrium near the set temperature T1 for a long period of time. In this case, heating or cooling an interior of the vehicle is no longer high priority, so the air quality inside the vehicle may be controlled. In other words, if the vehicle interior temperature T2 has not yet been adjusted to the user-entered set temperature T1, the interior of the vehicle may have to be kept relatively sealed. In this case, when the vehicle is ventilated, the vehicle interior temperature T2 reaches the set temperature T1 later, which affects control of the temperature inside the vehicle.

Accordingly, determining that the vehicle interior temperature T2 approaches the set temperature T1 by the automatic ventilation controller 16 is one of the prerequisites for the vehicle to proceed with ventilation.

Specifically, in the process of determining whether the vehicle interior temperature T2 approaches the set temperature T1, the automatic ventilation controller 16 may calculate an absolute value of a difference between the vehicle interior temperature T2 and the set temperature T1, and determine whether the calculated absolute value of the difference between the vehicle interior temperature T2 and the set temperature T1 is less than or equal to a threshold value T0 (for example, 3° C.). If the calculated absolute value of the difference between the vehicle interior temperature T2 and the set temperature T1 is less than or equal to the threshold value T0, the automatic ventilation controller 16 may determine that the vehicle interior temperature T2 approaches the set temperature T1.

In summary, when it is determined that an automatic ventilation mode is turned on by the automatic ventilation controller 16, there is no rain outside the vehicle, the vehicle speed V is within a predetermined range, and the vehicle interior temperature T2 approaches the set temperature T1, the automatic ventilation controller 16 may control the vehicle to perform ventilation.

Communication may be possible between the sunroof controller 17 and the automatic ventilation controller 16. Accordingly, during the process of the vehicle being ventilated, the automatic ventilation controller 16 may send a control command to the sunroof controller 17 to open the sunroof 19, thereby discharging low-quality air inside the vehicle through the sunroof 19 and allowing fresh air outside the vehicle to be introduced through the sunroof 19.

Additionally, according to an embodiment of the present disclosure, when the vehicle is ventilated, the automatic ventilation controller 16 may send a control command to the sunroof controller 17 to open the sunroof 19 to a predetermined opening ratio. Herein, the opening ratio may refer to a degree to which a window, a door, or other openable object is opened, and may be usually expressed as a degree or a percentage. In an embodiment of the present disclosure, the opening ratio may indicate a degree to which the sunroof 19 is opened and may be expressed as a percentage.

For the purpose of reducing noise, the predetermined range may be divided into at least two subranges. The automatic ventilation controller 16 may be configured to determine a subrange to which the vehicle speed V belongs before determining whether the vehicle interior temperature T2 is close to the set temperature T1 after determining that the vehicle speed V is within the predetermined range. Additionally, in different subranges, the predetermined opening ratio of the sunroof 19 when the vehicle speed V is relatively large may be smaller than the predetermined opening ratio of the sunroof 19 when the vehicle speed Vis relatively small.

In addition, after sending a control command to open the sunroof 19 to a predetermined opening ratio by the automatic ventilation controller 16 the automatic ventilation controller 16 may determine whether a predetermined time has elapsed after the sunroof 19 is opened. When it is determined that the predetermined time has elapsed since the sunroof 19 was opened, the automatic ventilation controller 16 may send a control command to close the sunroof 19.

The predetermined time for the sunroof 19 to open may be set based on a time required for the vehicle to complete air exchange inside and outside the vehicle. For example, if the vehicle speed Vis high, an amount of air intake when the vehicle is ventilated is large, and a speed of air exchange inside and outside the vehicle is fast, so the time for the sunroof 19 to open may be set short. Additionally, in different subranges, the predetermined time for opening the sunroof 19 when the vehicle speed Vis relatively high may be shorter than the predetermined time for opening the sunroof 19 when the vehicle speed V is relatively low.

Table 1 exemplarily illustrates a relationship between a range of vehicle speed V, the predetermined opening ratio of the sunroof, and the predetermined time for the sunroof to open. As shown in Table 1, the predetermined range (V<40 Km/h) may be divided into four subranges. Taking data of the first two subranges in Table 1 as an example, the predetermined opening ratio of 11% of the sunroof 19 when the range of the vehicle speed Vis 30 Km/h≤V<40 Km/h is smaller than the predetermined opening ratio of 12% of the sunroof 19 when the range of the vehicle speed Vis 20 Km/h≤V<30 Km/h, and the predetermined opening time of 8.52 min of the sunroof 19 when the range of the vehicle speed V may be 30 Km/h≤V<40 Km/h is smaller than the predetermined opening time of 9.02 min of the sunroof 19 when the range of the vehicle speed Vis 20 Km/h≤V<30 Km/h.

TABLE 1

| | Predetermined | Predetermined time |
|---|---|---|
| Subrange to which vehicle | opening | for which |
| speed V belongs | ratio of sunroof | sunroof is opened |
| 30 Km/h ≤ V < 40 Km/h | 11% | 8.52 min |
| 20 Km/h ≤ V < 30 Km/h | 12% | 9.02 min |
| 10 Km/h ≤ V < 20 Km/h | 15% | 9.16 min |
| V < 10 Km/h | 18% | 12.5 min |

Accordingly, as shown in Table 1, by establishing a relationship between the subrange to which the vehicle speed V belongs and the predetermined opening ratio of the sunroof 19 and the predetermined time for which the sunroof 19 is opened, air exchange inside and outside the vehicle may be implemented with low noise.

In addition to controlling the vehicle to ventilate through the sunroof 19, the automatic ventilation controller 16 may also control the vehicle to ventilate through the air conditioning device 18. An air intake mode of the air conditioning device 18 may include a recirculation mode and a fresh air mode. An airflow discharge mode may be determined by input of an occupant, and the occupant may determine an airflow discharge status by manipulating dampers of a defrost vent, a face-level vent, and a foot-level vent. Both the air intake mode and the airflow discharge mode of the air conditioning device 18 may be controlled through the air conditioning control system 15. When a vehicle occupant presses the defog button or selects the defog mode, the air conditioning control system 15 may receive the input of the occupant and activate the fresh air mode, allowing fresh outside air to be introduced into the air conditioning device 18. Fresh air may pass through a blower, an evaporator core, and/or a heater core inside the air conditioning device 18, where it is cooled or heated, and is then discharged through the defog vent of the air conditioning device 18 toward a front windshield glass and enters a vehicle interior. In different situations, a defog vent may achieve a defog purpose by discharging cool air to reduce a temperature difference between an interior and an exterior of the vehicle, or by discharging warm air to heat and evaporate water droplets on the front windshield glass into vapor, continuously supplying hot and dry air.

As described above, communication may be possible between the air conditioning control system 15 and the automatic ventilation controller 16. The automatic ventilation controller 16 may send a control command to the air conditioning control system 15 to activate a defogging function, which allows fresh outside air to be introduced into the vehicle.

In an embodiment of the present disclosure, the following determinations may be performed in any order or simultaneously: determining whether the automatic ventilation mode is turned on by the automatic ventilation controller 16, determining whether it is raining outside the vehicle, determining whether the vehicle speed V is within a predetermined range (furthermore, determining which a subrange of the predetermined range the vehicle speed Vis in), and determining whether the vehicle interior temperature T2 approaches the set temperature T1. Hereinafter, operation of the automatic ventilation controller 16 according to an embodiment of the present disclosure will be described in detail through a specific example.

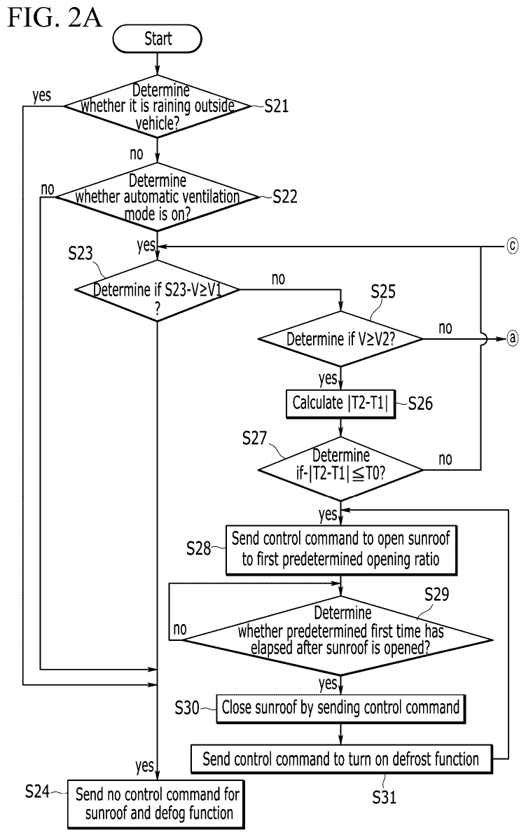

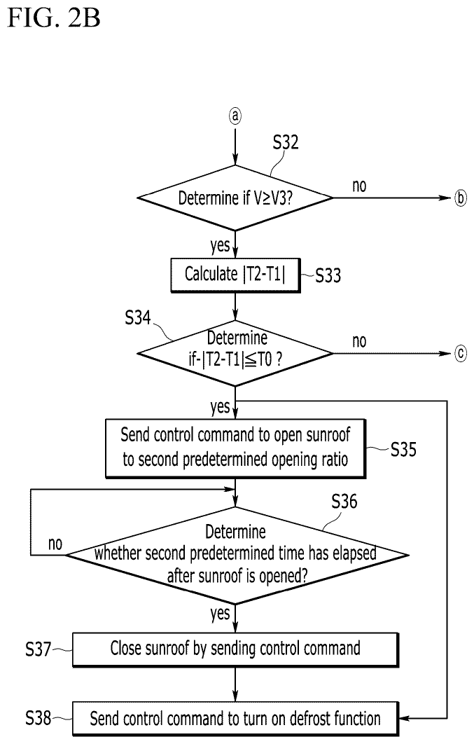

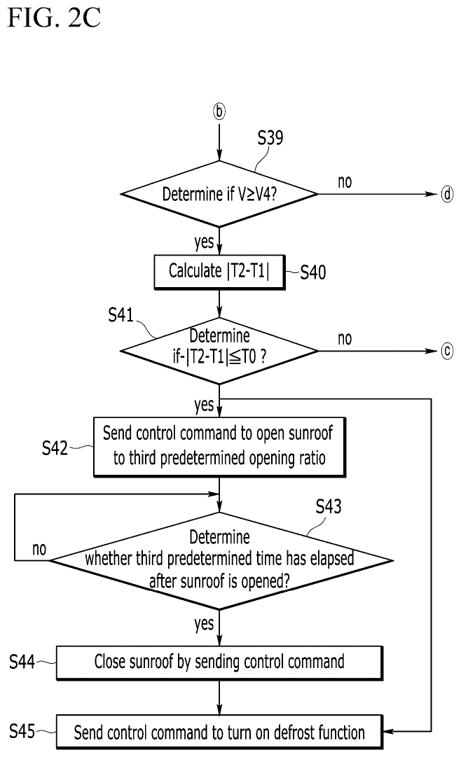

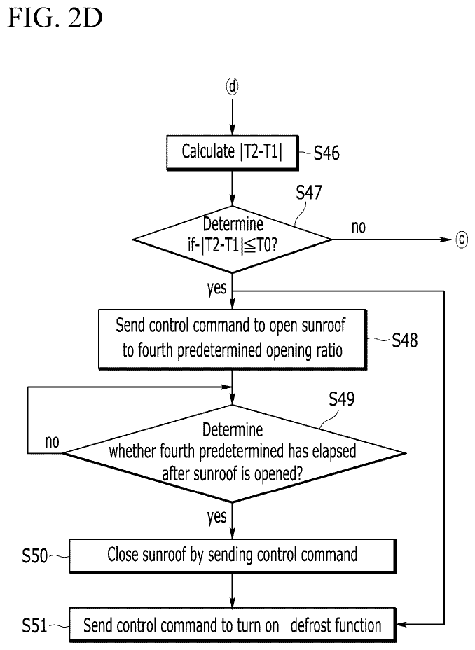

FIG. 2A to FIG. 2D illustrate flowcharts of operation of an automatic ventilation controller 16 according to an embodiment of the present disclosure. As shown in FIGS. 2A to 2D, the automatic ventilation controller 16 may determine whether rain is falling outside the vehicle based on at least one of an amount of rain outside the vehicle detected by the rain sensor 12 and the wiper operation status detected by the wiper detection module 13 (S21).

If it is determined that there is no rain outside the vehicle (“No” in Operation S21), the automatic ventilation controller 16 may determine whether an automatic ventilation mode is turned on based on the input received by the mode button 11 (S22).

If it is determined that the automatic ventilation mode is turned on (“Yes” in Operation S22), the automatic ventilation controller 16 may determine whether the vehicle speed V is greater than or equal to a first predetermined reference speed V1 (S23). Referring to Table 1, the first reference speed V1 may be 40 Km/h.

If it is determined that it is raining outside the vehicle (“Yes” in Operation S21), if it is determined that the automatic ventilation mode is turned off (“No” in Operation S22), or if it is determined that the vehicle speed V is greater than or equal to the first predetermined reference speed (“Yes” in Operation S23), the automatic ventilation controller 16 may not send a control command regarding the sunroof 19 and a defog function (S24).

If the vehicle speed V is determined to be less than the first predetermined reference speed V1 (“No” in Operation S23), the automatic ventilation controller 16 may determine whether the vehicle speed V is greater than or equal to a second predetermined reference speed V2 (S25), wherein the second reference speed V2 is less than the first reference speed V1. Referring to Table 1, the second reference speed V2 may be 30 Km/h.

If the vehicle speed V is determined to be greater than or equal to the second predetermined reference speed V2 (“Yes” in Operation S25), the automatic ventilation controller 16 may calculate an absolute value of a difference between the vehicle interior temperature T2 detected by the air conditioning control system 15 and the set temperature T1 received by the air conditioning control system 15 (S26).

The automatic ventilation controller 16 may determine whether the calculated absolute value of the difference between the vehicle interior temperature T2 and the set temperature T1 is less than or equal to the threshold value T0 (S27). For example, the threshold value T0 may be 3° C.

If the calculated absolute value of the difference between the vehicle interior temperature T2 and the set temperature T1 is greater than the threshold value T0 (“No” in Operation S27), the operation of the automatic ventilation controller 16 may return to Operation S23.

If the calculated absolute value of the difference between the vehicle interior temperature T2 and the set temperature T1 is less than or equal to the threshold value T0 (“Yes” in Operation S27), the automatic ventilation controller 16 may send a control command to open the sunroof 19 to a first predetermined opening ratio (S28). Referring to Table 1, the first predetermined opening ratio may be 11%.

The automatic ventilation controller 16 may determine whether a first predetermined time has elapsed after the sunroof 19 is opened (S29), and if it is determined that the first predetermined time has elapsed after the sunroof 19 is opened (“Yes” at Operation S29), the automatic ventilation controller 16 may send a control command to close the sunroof 19 (S30). Referring to Table 1, the first predetermined time may be 8.52 min.

In addition, if the calculated absolute value of the difference between the vehicle interior temperature T2 and the set temperature T1 is less than or equal to the threshold value T0 (“Yes” in Operation S27), the automatic ventilation controller 16 may send a control command to turn on a defog or defrost function (S31).

Returning to Operation S25, if the vehicle speed V is determined by the automatic ventilation controller 16 to be less than the second predetermined reference speed V2 (“NO” in Operation S25), the automatic ventilation controller 16 may determine whether the vehicle speed V is greater than or equal to a third predetermined reference speed V3 (S32), wherein the third reference speed V3 is less than the second reference speed V2. Referring to Table 1, the third reference speed V3 may be 20 Km/h.

If the vehicle speed V is determined to be greater than or equal to the third predetermined reference speed V3 (“Yes” in Operation S32), the automatic ventilation controller 16 may calculate an absolute value of a difference between the vehicle interior temperature T2 and the set temperature T1 (S33).

The automatic ventilation controller 16 may determine whether the calculated absolute value of the difference between the vehicle interior temperature T2 and the set temperature T1 is less than or equal to the threshold value T0 (S34).

If the calculated absolute value of the difference between the vehicle interior temperature T2 and the set temperature T1 is greater than the threshold value T0 (“No” in Operation S34), the operation of the automatic ventilation controller 16 may return to Operation S23.

If the calculated absolute value of the difference between the vehicle interior temperature T2 and the set temperature T1 is less than or equal to the threshold value T0 (“Yes” in Operation S34), the automatic ventilation controller 16 may send a control command to open the sunroof 19 to a second predetermined opening ratio (S35), wherein the second predetermined opening ratio is greater than the first predetermined opening ratio. Referring to Table 1, the second predetermined opening ratio may be 12%.

The automatic ventilation controller 16 may determine whether a second predetermined time has elapsed after the sunroof is opened (S36). When it is determined that the second predetermined time has elapsed since the sunroof 19 was opened (“Yes” in Operation S36), the automatic ventilation controller 16 may send a control command to close the sunroof 19 (S37). The second predetermined time may be greater than the first predetermined time. Referring to Table 1, the second predetermined time may be 9.02 min.

In addition, if the calculated absolute value of the difference between the vehicle interior temperature T2 and the set temperature T1 is less than or equal to the threshold value T0 (“Yes” in Operation S34), the automatic ventilation controller 16 may send a control command to turn on the defog function (S38).

Returning to Operation S32, if the vehicle speed V is determined by the automatic ventilation controller 16 to be less than the third predetermined reference speed V3 (“NO” in Operation S32), the automatic ventilation controller 16 may determine whether the vehicle speed V is greater than or equal to a fourth predetermined reference speed V4 (S39), wherein the fourth reference speed V4 is less than the third reference speed V3. Referring to Table 1, the fourth reference speed V4 may be 10 Km/h.

If the vehicle speed V is determined to be greater than or equal to the fourth predetermined reference speed V4 (“Yes” in Operation S39), the automatic ventilation controller 16 may calculate an absolute value of a difference between the vehicle interior temperature T2 and the set temperature T1 (S40).

The automatic ventilation controller 16 may determine whether the calculated absolute value of the difference between the vehicle interior temperature T2 and the set temperature T1 is less than or equal to the threshold value T0 (S41).

If the calculated absolute value of the difference between the vehicle interior temperature T2 and the set temperature T1 is greater than the threshold value T0 (“No” in Operation S41), the operation of the automatic ventilation controller 16 may return to Operation S23.

If the calculated absolute value of the difference between the vehicle interior temperature T2 and the set temperature T1 is less than or equal to the threshold value T0 (“Yes” in Operation S41), the automatic ventilation controller 16 may send a control command to open the sunroof 19 to a third predetermined opening ratio (S42), wherein the third predetermined opening ratio is greater than the second predetermined opening ratio. Referring to Table 1, the third predetermined opening ratio may be 15%.

The automatic ventilation controller 16 may determine whether a third predetermined time has elapsed after the sunroof 19 is opened (S43). When it is determined that the third predetermined time has elapsed since the sunroof 19 was opened (“Yes” in Operation S43), the automatic ventilation controller 16 may send a control command to close the sunroof 19 (S44). The third predetermined time may be greater than the second predetermined time. Referring to Table 1, the third predetermined time may be 9.16 min.

In addition, if the calculated absolute value of the difference between the vehicle interior temperature T2 and the set temperature T1 is less than or equal to the threshold value T0 (“Yes” in Operation S41), the automatic ventilation controller 16 may send a control command to turn on the defog function (S45).

Returning to Operation S39, if the vehicle speed V is determined by the automatic ventilation controller 16 to be less than the fourth predetermined reference speed V4 (“No” in Operation S39), the automatic ventilation controller 16 may calculate an absolute value of a difference between the vehicle interior temperature T2 and the set temperature T1 (S46).

The automatic ventilation controller 16 may determine whether the calculated absolute value of the difference between the vehicle interior temperature T2 and the set temperature T1 is less than or equal to the threshold value T0 (S47).

If the calculated absolute value of the difference between the vehicle interior temperature T2 and the set temperature T1 is greater than the threshold value T0 (“No” in Operation S47), the operation of the automatic ventilation controller 16 may return to Operation S23.

If the calculated absolute value of the difference between the vehicle interior temperature T2 and the set temperature T1 is less than or equal to the threshold value T0 (“Yes” in Operation S47), the automatic ventilation controller 16 may send a control command to open the sunroof 19 to a fourth predetermined opening ratio (S48), wherein the fourth predetermined opening ratio is greater than the third predetermined opening ratio. Referring to Table 1, the fourth predetermined opening ratio may be 18%.

The automatic ventilation controller 16 may determine whether a fourth predetermined time has elapsed after the sunroof 19 is opened (S49). When it is determined that the fourth predetermined time has elapsed since the sunroof 19 was opened (“Yes” in Operation S49), the automatic ventilation controller 16 may send a control command to close the sunroof 19 (S50). The fourth predetermined time may be greater than the third predetermined time. Referring to Table 1, the fourth predetermined time may be 12.5 min.

In addition, if the calculated absolute value of the difference between the vehicle interior temperature T2 and the set temperature T1 is less than or equal to the threshold value T0 (“Yes” in Operation S47), the automatic ventilation controller 16 may send a control command to turn on the defog function (S51).

According to an embodiment of the present disclosure, when the sunroof controller 17 receives a control command to open the sunroof 19 from the automatic ventilation controller 16, it may control the sunroof 19 to open to a predetermined opening ratio. Accordingly, after the sunroof 19 is opened, low-quality air inside the vehicle may be discharged through the sunroof 19, while fresh air from outside the vehicle may be introduced through the sunroof 19. When the sunroof controller 17 receives a control command to close the sunroof 19 from the automatic ventilation controller 16, it may control the sunroof 19 to be closed.

When the air conditioning control system 15 receives a control command to turn on a defog function from the automatic ventilation controller 16, the air conditioning control system 15 may determine whether the defog function is currently turned on. If it is determined that the defog function is currently on, it may indicate that fresh air is being introduced into the vehicle interior, so the air conditioning control system 15 may maintain the defog function to be activated at a current airflow speed. If it is determined that the defog function is not currently turned on, the air conditioning control system 15 may turn on the defog function and control the defog function to be activated at an intermediate airflow speed, thereby allowing fresh air to flow into the vehicle interior.

An embodiment of the present disclosure may further provide an automatic ventilation control method for a vehicle. The automatic ventilation control method for a vehicle according to an embodiment of the present disclosure utilizes the automatic ventilation control system for the vehicle illustrated in FIG. 1. Hereinafter, a method for controlling automatic ventilation of a vehicle according to an embodiment of the present disclosure will be described in detail.

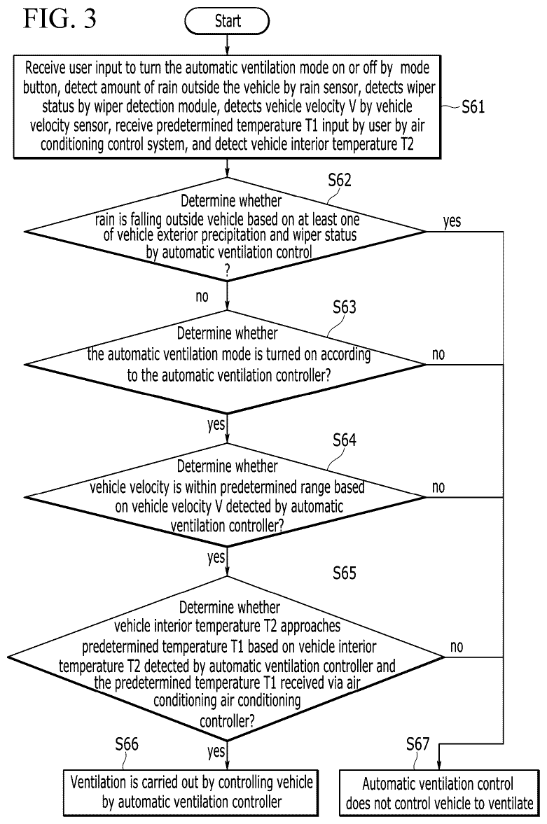

FIG. 3 illustrates a flowchart showing a control method for automatic ventilation of a vehicle according to an embodiment of the present disclosure. As illustrated in FIG. 3, the automatic ventilation control method for a vehicle according to an embodiment of the present disclosure may include an operation (S61) of receiving user input of turning an automatic ventilation mode on or off by the mode button 11, detecting an amount of rain outside the vehicle by the rain sensor 12, detecting a wiper operation status by the wiper detection module 13, detecting the vehicle speed V by the vehicle speed sensor 14, receiving the set temperature T1 input by a user by the air conditioning control system 15, and detecting the vehicle interior temperature T2.

Thereafter, it may determine whether the automatic ventilation mode is turned on according to the input received by the mode button 11 by the automatic ventilation controller 16 (S63), whether it is raining outside the vehicle according to at least one of the amount of rain outside the vehicle detected by the rain sensor 12 and the wiper operation status detected by the wiper detection module 13 (S62), whether the vehicle speed V detected by the vehicle speed sensor 14 is within a predetermined range according to the vehicle speed V detected by the air conditioning control system 15 (S64), and whether the vehicle interior temperature approaches the set temperature according to the vehicle interior temperature T2 detected by the air conditioning control system 15 and the set temperature T1 received by the air conditioning control system 15 (S65).

When it is determined that an automatic ventilation mode is turned on, there is no rain outside the vehicle, the vehicle speed V is within a predetermined range, and the vehicle interior temperature T2 approaches the set temperature T1, the vehicle may be controlled by the automatic ventilation controller 16 to perform ventilation (S66).

The embodiment of the present disclosure may not limit an execution order of determining whether the automatic ventilation mode is turned on by the automatic ventilation controller 16, determining whether it is raining outside the vehicle, determining whether the vehicle speed V is within a predetermined range and determining whether the vehicle interior temperature T2 approaches the set temperature T1, and these may be executed in different orders or simultaneously.

As an example, as shown in FIG. 3, after Operation S61, by the automatic ventilation controller 16, it may be determined whether rain is falling outside the vehicle based on at least one of an amount of rain outside the vehicle detected by the rain sensor 12 and the wiper operation status detected by the wiper detection module 13 (S62).

If it is determined that there is no rain outside the vehicle (“No” in Operation S62), by the automatic ventilation controller 16, it may be determined whether an automatic ventilation mode is turned on based on the input received by the mode button (S63).

If it is determined that the automatic ventilation mode is on (“Yes” at Operation S63), by the automatic ventilation controller 16, it may be determined whether the vehicle speed V is within the predetermined range based on the vehicle speed V detected by the vehicle speed sensor 14 (S64).

When the vehicle speed V is determined to be within the predetermined range (“Yes” at Operation S64), the vehicle interior temperature T2 detected by the air conditioning control system 15 by the automatic ventilation controller 16 and the set temperature T1 received by the air conditioning control system 15 may be used to determine whether the vehicle interior temperature T2 approach the set temperature T1 (S65).

When the temperature inside the vehicle T2 is determined to approach the set temperature T1 (“Yes” in Operation S65), the vehicle may be controlled by the automatic ventilation controller 16 to perform ventilation (S66).

However, if it is determined that it is raining outside the vehicle (“Yes” in Operation S62), if it is determined that the automatic ventilation mode is not turned on (“No” in Operation S63), if it is determined that the vehicle speed V is not within the predetermined range (“No” in Operation S64), or if it is determined that the vehicle interior temperature T2 does not approach the set temperature T1 (“No” in Operation S65), the automatic ventilation controller 16 may not control the vehicle to perform ventilation.

Specifically, the Operation S64 of determining whether the vehicle speed V is within the predetermined range by the automatic ventilation controller 16 may include an operation of determining whether the vehicle speed V detected by the vehicle speed sensor 14 by the automatic ventilation controller 16 is greater than or equal to the first predetermined reference speed V1. If the vehicle speed V is less than the first predetermined reference speed V1, by the automatic ventilation controller 16, it may be determined that the vehicle speed V is within the predetermined range.

After the vehicle speed is determined to be within the predetermined range by the automatic ventilation controller 16 (“Yes” in Operation S64), before the automatic ventilation controller 16 determines whether the vehicle interior temperature T2 approaches to the set temperature T1, operations of dividing the predetermined range into at least two subranges and determining the subrange to which the vehicle speed belongs may be included.

In Operation S66 of controlling the vehicle to perform ventilation by the automatic ventilation controller 16, the automatic ventilation controller 16 may send a control command to open the sunroof 19 to a predetermined opening ratio.

Additionally, in different subranges, the predetermined opening ratio of the sunroof 19 when the vehicle speed V is relatively large may be smaller than the predetermined opening ratio of the sunroof 19 when the vehicle speed V is relatively small.

Specifically, the operation of opening the sunroof 19 to the predetermined opening ratio by sending the control command by the automatic ventilation controller 16 may include an operation of determining, after the automatic ventilation controller 16 determines that the vehicle speed V is less than the first predetermined reference speed V1, whether the vehicle speed V is greater than or equal to the second predetermined reference speed V2, wherein the second reference speed V2 is less than the first reference speed V1. When the vehicle speed Vis determined to be greater than or equal to the second predetermined reference speed V2, by the automatic ventilation controller 16, it may be determined whether the vehicle interior temperature T2 approaches the set temperature T1. When the vehicle interior temperature T2 is determined to approaches the set temperature T1, a control command may be sent by the automatic ventilation controller 16 to open the sunroof 19 to a first predetermined opening ratio. If the vehicle speed V is determined to be less than the second predetermined reference speed V2, the automatic ventilation controller 16 may determine whether the vehicle speed V is greater than or equal to a third predetermined reference speed V3, wherein the third reference V3 is less than the second reference speed V2. When the vehicle speed V is determined to be greater than or equal to the third predetermined reference speed V3, by the automatic ventilation controller 16, it may be determined whether the vehicle interior temperature T2 approaches the set temperature T1. When the vehicle interior temperature T2 is determined to approach the set temperature T1, a control command may be sent by the automatic ventilation controller 16 to open the sunroof 19 to a second predetermined opening ratio, wherein the second predetermined opening ratio is greater than the first predetermined opening ratio. If the vehicle speed V is determined to be less than the third predetermined reference speed V3, the automatic ventilation controller 16 may determine whether the vehicle speed V is greater than or equal to a fourth predetermined reference speed V4, wherein the fourth reference V4 is less than the third reference speed V3. When the vehicle speed Vis determined to be greater than or equal to the fourth predetermined reference speed V4, by the automatic ventilation controller 16, it may be determined whether the vehicle interior temperature T2 approaches the set temperature T1. When the vehicle interior temperature T2 is determined to approach the set temperature T1, a control command may be sent by the automatic ventilation controller 16 to open the sunroof 19 to a third predetermined opening ratio, wherein the third predetermined opening ratio is greater than the second predetermined opening ratio. When the vehicle speed V is determined to be less than the fourth predetermined reference speed V4, by the automatic ventilation controller 16, it may be determined whether the vehicle interior temperature T2 approaches the set temperature T1. When the vehicle interior temperature T2 is determined to approach the set temperature T1, a control command may be sent by the automatic ventilation controller 16 to open the sunroof 19 to a fourth predetermined opening ratio, wherein the fourth predetermined opening ratio is greater than the third predetermined opening ratio.

In an embodiment, the Operation S65 of determining whether the vehicle interior temperature T2 approaches the set temperature T1 by the automatic ventilation controller 16 may include an operation of calculating an absolute value of a difference between the vehicle interior temperature T2 sensed by the automatic ventilation controller 16 through the air conditioning control system 15 and the set temperature T1 received through the air conditioning control system 15. Through the automatic ventilation controller 16, it may be determined whether the calculated absolute value of the difference between the vehicle interior temperature T2 and the set temperature T1 is less than or equal to the threshold value T0. If the calculated absolute value of the difference between the vehicle interior temperature T2 and the set temperature T1 is less than or equal to the threshold value T0, by the automatic ventilation controller 16, it may be determined that the vehicle interior temperature T2 approaches the set temperature T1.

The Operation S66 of controlling the vehicle to perform ventilation by the automatic ventilation controller 16 may include an operation of sending a control command to open the sunroof 19 to a predetermined opening ratio, determining whether a predetermined time has elapsed after the sunroof 19 is opened by the automatic ventilation controller 16, and, if it is determined that the predetermined time has elapsed after the sunroof 19 is opened, sending a control command by the automatic ventilation controller 16 to close the sunroof 19.

In addition, in different subranges, the predetermined time for opening the sunroof 19 when the vehicle speed V is relatively high may be shorter than the predetermined time for opening the sunroof 19 when the vehicle speed V is relatively low.

Specifically, the operation of closing the sunroof by sending the control command by the automatic ventilation controller 16 may include sending the control command by the automatic ventilation controller 16 to open the sunroof to a first predetermined opening ratio, and determining whether a first predetermined time has elapsed after the sunroof is opened by the automatic ventilation controller 16. The method may further include an operation of closing the sunroof by sending a control command by the automatic ventilation controller 16 when it is determined that the first predetermined time has elapsed after the sunroof is opened. The control command may be sent by the automatic ventilation controller 16 to open the sunroof to a second predetermined opening ratio, and it may be determined whether a second predetermined time has elapsed after the sunroof is opened by the automatic ventilation controller 16, wherein the second predetermined time is greater than the first predetermined time. When it is determined that the second predetermined time has elapsed after the sunroof has been opened, the control command may be sent by the automatic ventilation controller 16 to close the sunroof. The control command may be sent by the automatic ventilation controller 16 to open the sunroof to a third predetermined opening ratio, and it may be determined whether a third predetermined time has elapsed after the sunroof is opened, wherein the third predetermined time is greater than the second predetermined time. When it is determined that the third predetermined time has elapsed after the sunroof has been opened, the control command may be sent by the automatic ventilation controller 16 to close the sunroof. The control command may be sent by the automatic ventilation controller 16 to open the sunroof to a fourth predetermined opening ratio, and it may be determined whether a fourth predetermined time has elapsed after the sunroof is opened, wherein the fourth predetermined time is greater than the third predetermined time. When it is determined that the fourth predetermined time has elapsed after the sunroof has been opened, the control command may be sent by the automatic ventilation controller 16 to close the sunroof.

The automatic ventilation controller 16 may control the vehicle to ventilate through the sunroof 19 as well as control the vehicle to ventilate through the air conditioning device 18. Accordingly, the Operation S66 of controlling the vehicle to proceed with ventilation by the automatic ventilation controller 16 may include an operation of turning on a defog function by sending a control command by the automatic ventilation controller 16.

The method for controlling automatic ventilation of a vehicle may further include an operation of determining whether a defog function is currently turned on by the air conditioning control system 15 when the air conditioning control system 15 receives a control command from the automatic ventilation controller 16 to activate the defog function. If it is determined that the defog function is currently turned on, the defog function may be maintained to be activated at a current airflow speed by the air conditioning control system 15. If it is determined that the defog function is not currently turned on, the defog function may be turned on by the air conditioning control system 15, and the defog function may be controlled to be activated at an intermediate airflow speed.

The automatic ventilation control system and control method for a vehicle according to an embodiment of the present disclosure may implement a defog function for the air conditioning device 18 and automatic linkage control of the sunroof 19, thereby accelerating air exchange inside and outside a vehicle, improving comfort inside the vehicle, and preventing driving fatigue.

In addition, the automatic ventilation control system and control method for a vehicle according to an embodiment of the present disclosure may ensure that ventilation of the vehicle is performed on the premise that the temperature inside the vehicle is controlled by considering a difference between the vehicle interior temperature T2 and the set temperature T1, thereby ensuring the comfort of the temperature inside the vehicle and also implementing air exchange inside and outside the vehicle.

Furthermore, the automatic ventilation control system and control method for a vehicle according to an embodiment of the present disclosure may dynamically adjust a sunroof opening ratio and a sunroof opening time according to changes in the vehicle speed V, and implement low-noise air exchange inside and outside the vehicle.

In addition, the automatic ventilation control system and control method for a vehicle according to an embodiment of the present disclosure may improve safety of the vehicle driving process by avoiding manual input of a driver by implementing automatic control of ventilation during the vehicle driving process.

Various embodiments of the present disclosure may not enumerate all possible combinations, but rather illustrate representative aspects of the present disclosure, and furthermore, the contents described in the various embodiments may be applied independently or in combination of two or more.

While this present disclosure has been described in connection with what is presently considered to be practical embodiments, it can be understood that the present disclosure is not limited to the disclosed example embodiments. On the contrary, the present disclosure is intended to cover various modifications and equivalent arrangements included within the spirit and scopes of the appended claims.

1. An automatic ventilation control system for a vehicle, comprising:
a mode button configured to receive a user input to turn an automatic ventilation mode on or off;
at least one of a rain sensor or a wiper detection module;
a vehicle speed sensor configured to determine a vehicle speed;
an air conditioning control system configured to receive the user input for a set temperature and detect a vehicle interior temperature; and
an automatic ventilation controller configured to:
determine whether the automatic ventilation mode is on based on the user input received via the mode button;
determine whether the rain sensor or the wiper detection module detects rain;
determine whether the vehicle speed is within a predetermined range based on the vehicle speed detected by the vehicle speed sensor;
determine whether the vehicle interior temperature approaches the set temperature based on the vehicle interior temperature and the set temperature; and
control the vehicle to perform ventilation in response to determining that the automatic ventilation mode is on, determining that the rain sensor or the wiper detection module detects no rain, determining that the vehicle speed is within the predetermined range, and determining that the vehicle interior temperature approaches the set temperature.

2. The automatic ventilation control system of claim 1, wherein the automatic ventilation controller is further configured to:
determine whether the vehicle speed is greater than or equal to a first predetermined reference speed to determine whether the vehicle speed is within the predetermined range; and
determine that the vehicle speed is within the predetermined range in response to the vehicle speed being less than the first predetermined reference speed.

3. The automatic ventilation control system of claim 1, wherein the automatic ventilation controller is configured to:
calculate an absolute value of a difference between the vehicle interior temperature and the set temperature to determine whether the vehicle interior temperature approaches the set temperature;
determine whether the calculated absolute value of the difference between the vehicle interior temperature and the set temperature is less than or equal to a threshold value; and
determine that the vehicle interior temperature approaches the set temperature in response to the calculated absolute value of the difference between the vehicle interior temperature and the set temperature being less than or equal to the threshold value.

4. The automatic ventilation control system of claim 1, wherein the predetermined range comprises at least two subranges, and wherein the automatic ventilation controller is further configured to:
determine a subrange corresponding to the vehicle speed after determining that the vehicle speed is within the predetermined range and before determining whether the vehicle interior temperature approaches the set temperature; and
control the vehicle to open a sunroof to a predetermined opening ratio to perform ventilation, wherein, in different subranges, the predetermined opening ratio of the sunroof is smaller when the vehicle speed is relatively high than the predetermined opening ratio of the sunroof when the vehicle speed is relatively low.

5. The automatic ventilation control system of claim 4, wherein the automatic ventilation controller is further configured to:
determine whether a predetermined time has elapsed after opening the sunroof to the predetermined opening ratio, and
control the vehicle to close the sunroof in response to determining that the predetermined time has elapsed after opening the sunroof, wherein the predetermined time after opening the sunroof is shorter when the vehicle speed is relatively high than the predetermined time after opening the sunroof when the vehicle speed is relatively low.

6. The automatic ventilation control system of claim 1, wherein the automatic ventilation controller is further configured to:
determine whether the automatic ventilation mode is turned on in response to determining that the rain sensor or the wiper detection module detects no rain;
determine whether the vehicle speed is greater than or equal to a first predetermined reference speed in response to determining that the automatic ventilation mode is on;
determine whether the vehicle speed is greater than or equal to a second predetermined reference speed in response to determining that the vehicle speed is less than the first predetermined reference speed, wherein the second predetermined reference speed is less than the first predetermined reference speed;
calculate an absolute value of a difference between the vehicle interior temperature and the set temperature in response to determining that the vehicle speed is greater than or equal to the second predetermined reference speed;
determine whether the calculated absolute value of the difference between the vehicle interior temperature and the set temperature is less than or equal to a threshold value in response to the vehicle speed being greater than or equal to the second predetermined reference speed;
open a sunroof to a first predetermined opening ratio in response to determining that the calculated absolute value of the difference between the vehicle interior temperature and the set temperature is less than or equal to the threshold value and the vehicle speed being greater than or equal to the second predetermined reference speed;
determine whether a first predetermined time has elapsed after opening the sunroof to the first predetermined opening ratio;
close the sunroof in response to determining that the first predetermined time has elapsed after the sunroof is opened;
determine whether the vehicle speed is greater than or equal to a third predetermined reference speed in response to determining that the vehicle speed is less than the second predetermined reference speed, wherein the third predetermined reference speed is less than the second predetermined reference speed;
calculate the absolute value of the difference between the vehicle interior temperature and the set temperature in response determining that the vehicle speed is greater than or equal to the third predetermined reference speed;
determine whether the calculated absolute value of the difference between the vehicle interior temperature and the set temperature is less than or equal to the threshold value in response to the vehicle speed being greater than or equal to the third predetermined reference speed;
open the sunroof to a second predetermined opening ratio in response to determining that the calculated absolute value of the difference between the vehicle interior temperature and the set temperature is less than or equal to the threshold value and the vehicle speed being greater than or equal to the third predetermined reference speed, wherein the second predetermined opening ratio is greater than the first predetermined opening ratio;
determine whether a second predetermined time has elapsed after the sunroof is opened to the second predetermined opening ratio, wherein the second predetermined time is greater than the first predetermined time;
close the sunroof in response to determining that the second predetermined time has elapsed after the sunroof is opened;
determine whether the vehicle speed is greater than or equal to a fourth predetermined reference speed in response to determining that the vehicle speed is less than the third predetermined reference speed, wherein the fourth predetermined reference speed is less than the third predetermined reference speed;
calculate the absolute value of the difference between the vehicle interior temperature and the set temperature in response to determining that the vehicle speed is greater than or equal to the fourth predetermined reference speed;
determine whether the calculated absolute value of the difference between the vehicle interior temperature and the set temperature is less than or equal to the threshold value in response to the vehicle speed being greater than or equal to the fourth predetermined reference speed;
open the sunroof to a third predetermined opening ratio in response to determining that the calculated absolute value of the difference between the vehicle interior temperature and the set temperature is less than or equal to the threshold value and the vehicle speed being greater than or equal to the fourth predetermined reference speed, wherein the third predetermined opening ratio is greater than the second predetermined opening ratio;
determine whether a third predetermined time has elapsed after the sunroof is opened to the third predetermined opening ratio, wherein the third predetermined time is greater than the second predetermined time;
close the sunroof based on that determining that the third predetermined time has elapsed after the sunroof is opened;
calculate the absolute value of the difference between the vehicle interior temperature and the set temperature in response to determining that the vehicle speed is less than the fourth predetermined reference speed;
determine whether the calculated absolute value of the difference between the vehicle interior temperature and the set temperature is less than or equal to the threshold value in response to the vehicle speed being less than the fourth predetermined reference speed;
open the sunroof to a fourth predetermined opening ratio in response to determining that the calculated absolute value of the difference between the vehicle interior temperature and the set temperature is less than or equal to the threshold value and the vehicle speed being less than the fourth predetermined reference speed, wherein the fourth predetermined opening ratio is greater than the third predetermined opening ratio;
determine whether a fourth predetermined time has elapsed after the sunroof is opened to the fourth predetermined opening ratio, wherein the fourth predetermined time is greater than the third predetermined time; and
close the sunroof in response to determining that the fourth predetermined time is determined to have elapsed after the sunroof is opened.

7. The automatic ventilation control system of claim 1, wherein the automatic ventilation controller is configured to: control the vehicle to turn on a defog function to perform ventilation.

8. The automatic ventilation control system of claim 7, wherein the air conditioning control system is configured to:
determine whether the defog function is turned on in response to receiving a control command to activate the defog function from the automatic ventilation controller;
maintain the activated defog function at a current airflow speed in response to determining that the defog function is on; and
turn on the defog function and activate the defog function at an intermediate airflow speed in response to determining that the defog function is not turned on.

9. An automatic ventilation control method for a vehicle, comprising:
receiving a user input of turning an automatic ventilation mode on or off by a mode button;
determine a vehicle speed by a vehicle speed sensor;
receiving the user input for a set temperature and determining a vehicle interior temperature by an air conditioning control system;
determining whether the automatic ventilation mode is turned on based on the user input received by the mode button;
determining whether a rain sensor or a wiper detection module detects rain;
determining whether the vehicle speed is within a predetermined range based on the vehicle speed detected by the vehicle speed sensor; and
determining whether the vehicle interior temperature approaches the set temperature based on the vehicle interior temperature and the set temperature, by an automatic ventilation controller; and
controlling the vehicle to perform ventilation by the automatic ventilation controller in response to determining that the automatic ventilation mode is on, that no rain is detected, the vehicle speed is within the predetermined range, and the vehicle interior temperature approaches the set temperature.

10. The automatic ventilation control method of claim 9, wherein:
determining whether the automatic ventilation mode is on comprises determining whether the automatic ventilation mode is turned on in response to determining that no rain is detected;
determining whether the vehicle speed is within the predetermined range comprises determining whether the vehicle speed is within the predetermined range in response to determining that the automatic ventilation mode is on;
determining whether the vehicle temperature is approaching the set temperature comprises determining whether the vehicle interior temperature approaches the set temperature in response to determining that the vehicle speed is within the predetermined range; and
controlling the vehicle to perform ventilation comprises controlling the vehicle to perform ventilation in response to determining that the vehicle interior temperature approaches the set temperature.

11. The automatic ventilation control method of claim 10, wherein the determining whether the vehicle speed is within the predetermined range comprises:
determining whether the vehicle speed is greater than or equal to a first predetermined reference speed; and
determining that the vehicle speed is within the predetermined range in response to determining that the vehicle speed is less than the first predetermined reference speed.

12. The automatic ventilation control method of claim 11, wherein the predetermined range comprises at least two subranges, the method further comprises:
determining a subrange corresponding to the vehicle speed before determining whether the vehicle interior temperature is approaching the set temperature and after determining that the vehicle speed is within the predetermined range,
wherein controlling the vehicle to perform ventilation comprises opening a sunroof to a predetermined opening ratio, and
wherein, in different subranges, the predetermined opening ratio of the sunroof is smaller when the vehicle speed is relatively high than the predetermined opening ratio of the sunroof when the vehicle speed is relatively low.

13. The automatic ventilation control method of claim 12, wherein the opening the sunroof to the predetermined opening ratio comprises:
determining whether the vehicle speed is greater than or equal to a second predetermined reference speed after the vehicle speed is determined to be less than the first predetermined reference speed, wherein the second predetermined reference speed is less than the first predetermined reference speed;
determining whether the vehicle interior temperature approaches the set temperature in response to determining that the vehicle speed is greater than or equal to the second predetermined reference speed;
opening the sunroof to a first predetermined opening ratio in response to determining that the vehicle interior temperature approaches the set temperature;
determining whether the vehicle speed is greater than or equal to a third predetermined reference speed in response to determining that the vehicle speed is less than the second predetermined reference speed, wherein the third predetermined reference speed is less than the second predetermined reference speed;
determining whether the vehicle interior temperature approaches the set temperature in response to determining that the vehicle speed is greater than or equal to the third predetermined reference speed;
opening the sunroof to a second predetermined opening ratio in response to determining that the vehicle interior temperature approaches the set temperature, wherein the second predetermined opening ratio is greater than the first predetermined opening ratio;
determining whether the vehicle speed is greater than or equal to a fourth predetermined reference speed in response to determining that the vehicle speed is less than the third predetermined reference speed, wherein the fourth predetermined reference speed is less than the third predetermined reference speed;
determining whether the vehicle interior temperature approaches the set temperature in response to determining that the vehicle speed is greater than or equal to the fourth predetermined reference speed;
opening the sunroof to a third predetermined opening ratio in response to determining that the vehicle interior temperature approaches the set temperature, wherein the third predetermined opening ratio is greater than the second predetermined opening ratio;
determining whether the vehicle interior temperature approaches the set temperature in response to determining that the vehicle speed is less than the fourth predetermined reference speed; and
opening the sunroof to a fourth predetermined opening ratio in response to determining that the vehicle interior temperature approaches the set temperature, wherein the fourth predetermined opening ratio is greater than the third predetermined opening ratio.

14. The automatic ventilation control method of claim 13, wherein the determining whether the vehicle interior temperature approaches the set temperature comprises:
calculating an absolute value of a difference between the vehicle interior temperature detected by the air conditioning control system and the set temperature received by the air conditioning control system;
determining whether the calculated absolute value of the difference between the vehicle interior temperature and the set temperature is less than or equal to a threshold value; and
determining that the vehicle interior temperature approaches the set temperature when the calculated absolute value of the difference between the vehicle interior temperature and the set temperature is less than or equal to the threshold value.

15. The automatic ventilation control method of claim 13, wherein the controlling the vehicle to perform ventilation comprises:
determining, after opening the sunroof to the predetermined opening ratio, whether a predetermined time has elapsed after opening the sunroof; and
closing the sunroof in response to determining that the predetermined time has elapsed after the sunroof is opened, wherein, in different subranges, the predetermined time for opening the sunroof is shorter when the vehicle speed is relatively high than the predetermined time for opening the sunroof when the vehicle speed is relatively low.

16. The automatic ventilation control method of claim 15, wherein the closing the sunroof comprises:
determining whether a first predetermined time has elapsed after opening the sunroof to the first predetermined opening ratio;
closing the sunroof in response to determining that the first predetermined time has elapsed after the sunroof is opened;
determining whether a second predetermined time has elapsed after opening the sunroof to the second predetermined opening ratio, wherein the second predetermined time is greater than the first predetermined time;
closing the sunroof in response to determining that the second predetermined time has elapsed after the sunroof is opened;
determining whether a third predetermined time has elapsed after opening the sunroof to the third predetermined opening ratio, wherein the third predetermined time is greater than the second predetermined time;
closing the sunroof in response to determining that the third predetermined time has elapsed after the sunroof is opened;
determining whether a fourth predetermined time has elapsed after opening the sunroof to the fourth predetermined opening ratio, wherein the fourth predetermined time is greater than the third predetermined time; and
closing the sunroof in response to determining that the fourth predetermined time has elapsed after the sunroof is opened.

17. The automatic ventilation control method of claim 9, wherein the controlling the vehicle to perform ventilation comprises turning on a defog function.

18. The automatic ventilation control method of claim 17, further comprising:
determining whether the defog function is turned on by the air conditioning control system in response to receiving a control command to activate the defog function;
maintaining the activated defog function at a current airflow speed by the air conditioning control system determining that the defog function is turned on; and
turning on the defog function and controlling the defog function to be activated at an intermediate airflow speed by the air conditioning control system in response to determining that the defog function is not turned on.

19. An automatic ventilation control system for a vehicle, comprising:
a mode button configured to receive a user input to turn an automatic ventilation mode on or off;
at least one of a rain sensor or a wiper detection module;
a vehicle speed sensor configured to determine a vehicle speed;
an air conditioning control system configured to receive the user input for a set temperature and determine a vehicle interior temperature; and
an automatic ventilation controller configured to:
determine whether the automatic ventilation mode is on;
determine whether the rain sensor or the wiper detection module detects rain;
determine whether the vehicle speed is within a predetermined range;
determine whether the vehicle interior temperature is approaching the set temperature in response an absolute value of a difference between the vehicle interior temperature and the set temperature being less than or equal to a threshold value; and
control the vehicle to perform ventilation in response to determining that the automatic ventilation mode is on, the rain sensor or the wiper detection module detects no rain, the vehicle speed is within the predetermined range, and the vehicle interior temperature is approaching the set temperature.

20. The automatic ventilation control system of claim 19, wherein the predetermined range comprises a first subrange, a second subrange, a third subrange, and a fourth subrange, and wherein the automatic ventilation controller is further configured to:
determine whether the vehicle speed is in the first subrange, the second subrange, the third subrange, or the fourth subrange;
control the vehicle to open a sunroof to a first predetermined opening ratio in response to the vehicle speed being within the first subrange;
control the vehicle to close the sunroof in response to a first predetermined time elapsing after opening the sunroof to the first predetermined opening ratio;
control the vehicle to open the sunroof to a second predetermined opening ratio in response to the vehicle speed being within the second subrange;
control the vehicle to close the sunroof in response to a second predetermined time elapsing after opening the sunroof to the second predetermined opening ratio, wherein the second subrange is less than the first subrange, the second predetermined opening ratio is greater than the first predetermined opening ratio, and the second predetermined time is greater than the first predetermined time;
control the vehicle to open the sunroof to a third predetermined opening ratio in response to the vehicle speed being within the third subrange;
control the vehicle to close the sunroof in response to a third predetermined time elapsing after opening the sunroof to the third predetermined opening ratio, wherein the third subrange is less than the second subrange, the third predetermined opening ratio is greater than the second predetermined opening ratio, and the third predetermined time is greater than the second predetermined time;
control the vehicle to open the sunroof to a fourth predetermined opening ratio in response to the vehicle speed being within the fourth subrange; and
control the vehicle to close the sunroof in response to a fourth predetermined time elapsing after opening the sunroof to the fourth predetermined opening ratio, wherein the fourth subrange is less than the third subrange, the fourth predetermined opening ratio is greater than the third predetermined opening ratio, and fourth predetermined time is greater than the third predetermined time.
